(19) United States
(12) Patent Application Publication
(10) Pub. No.: US 2008/0045201 A1
(43) Pub. Date: Feb. 21, 2008

(54) REMOTE FEATURE CONTROL OF A MOBILE DEVICE

(76) Inventor: Jonathan K. KIES, Encinitas, CA (US)

Correspondence Address: QUALCOMM INCORPORATED, 5775 MOREHOUSE DR., SAN DIEGO, CA, 92121, US

(21) Appl. No.: 11/465,187

(22) Filed: Aug. 17, 2006

(51) Int. Cl. H04M 3/00

(52) U.S. Cl. 455/420

(57) ABSTRACT

One mobile device in a group of mobile devices, such as a “family plan” or a “business plan”, is identified as a master phone. The master phone issues messages, such as special SMS messages, to the other mobile devices in the group. These special SMS messages are operative to control features (e.g., enable/disable certain applications, programs, or services) on the other mobile devices.

### BACKGROUND OF THE INVENTION

The invention relates generally to the field of device configuration, and more particularly to remote configuration of wireless devices.

Mobile devices today are capable of performing many tasks. Conventional mobile devices include the capability of sending data and receiving data at the device, such as text messaging, email, video telephony, web browsing, and the like. Conventional mobile devices operate within a cellular network. Typically, a cellular device, when purchased, is provisioned and is provided with subscribed services based on a purchaser's decisions. The subscribed services can be modified at a later date. Services available for subscription include those previously mentioned as well as additional entertainment services (e.g., cell phone games) and other services too numerous to detail.

Conventional use of cellular devices has grown dramatically throughout this decade to include most families providing one or more devices to their family members, often including children. The reasons for providing cellular capabilities to children are many, and include added security (e.g., a child can call parents or authorities if she feels threatened), accountability (e.g., a parent can contact the child at almost any time to keep track of her), convenience (e.g., a child can contact a parent for a ride when a landline is not available), and the like. Unfortunately, many of the currently available services subscribed to by mobile device owners may not be desirable for all of the cellular devices within a household. For example, video telephony may expose certain users (e.g., juveniles) to content that is undesirable to parents. In another example, it may be desirable to block access to certain websites or to deny access to the internet in its entirety. In yet another example, it may be desirable to deny access to text messaging, such as to reduce additional expenses to the subscription contract.

Typically, the mobile devices can be programmed for desired services when purchased or modified by contacting the service provider. However, these solutions are cumbersome and require the expenditure of time and effort of the mobile device owner as well as resources of the service provider. Additionally, family needs may change frequently regarding one or more of the mobile devices provided to family members as well as the services provided to each mobile device.

A superior method for controlling access to services on a mobile device has eluded those skilled in the art, until now.

### SUMMARY OF THE INVENTION

The invention is directed to remotely controlling access to services and/or features on a mobile device that is a member of a group of associated mobile devices. Briefly stated, the present invention is directed to establishing one of the mobile devices within the group of mobile devices as the senior device and providing the senior mobile device with the capabilities to enable or disable specific services available to the other mobile devices with the group via the use of permissions.

In one aspect, a method is provided for utilizing a mobile device to modify subscribed services on a subordinate mobile device within a communications, and a computer-readable medium encoded with instructions for performing the method. The method includes authenticating a user of a senior mobile device that is a member of a mobile device plan, the authentication being based on input data, the mobile device plan including at least the senior mobile device and one or more other mobile devices; determining a subordinate mobile device from the mobile device plan members based on the input data, the subordinate mobile device having modifiable subscribed services; determining at least one modifiable subscribed service on the determined subordinate mobile device to be modified based on the input data; determining a modification to be applied to the at least one modifiable subscribed service based on the input data; generating instructions for the determined subordinate mobile device based on the determined modifications to the at least one modifiable subscribed service associated with the determined subordinate mobile device; and sending the generated instructions to the subordinate mobile device.

In another aspect, a method is provided for modifying subscribed services on a subordinate mobile device operating within a communication system, and a computer-readable medium encoded with instructions for performing the method. The method includes receiving a transmission to a subordinate mobile device associated with a mobile device plan operating within a communications system, the transmission including instructions to modify at least one modifiable subscribed service operating on the subordinate mobile device, the instructions originating from a senior mobile device associated with the mobile device plan, the subordinate mobile device subordinate to the senior mobile device; authenticating the received transmission; parsing the authenticated received transmission; identifying instructions from the parsed received transmission, the identified instructions associated with at least one modifiable subscribed service operating on the subordinate mobile device; and modifying the at least one modifiable subscribed service based on the identified instructions.

In yet another aspect, a system for providing a senior mobile device of a mobile device plan with remote control of subscribed services operating on a subordinate mobile device is provided. The system includes a cellular communication system infrastructure, a senior mobile device associated with a mobile device plan, and a subordinate mobile device associated with the mobile device plan and in communication with the senior mobile device. The senior mobile device includes: a first communication bus; at least a first communication port; a first user interface; at least a first processor; at least a first memory storage device in communication with the processor; and a first computer readable memory device which is readable by the first processor. The first computer readable memory device includes a series of computer executable steps configured to cause the first processor to: determine a subordinate mobile device from members of a mobile device plan, based on input data, the subordinate mobile device having modifiable subscribed services; determine at least one modifiable subscribed service, operating on the determined subordinate mobile device, to be modified based on the input data; determine a modification to be applied to the at least one modifiable subscribed service based on the input data; generate instructions for the determined subordinate mobile device based on the determined modifications to the at least one modifiable subscribed service associated with the determined subordinate mobile device; and send the generated instructions to the subordinate mobile device. The subordinate mobile device includes: a second communication bus; at least a second communication port; a second user interface; at least a second processor; at least a second memory storage device in communication with the processor; and at least a second computer readable memory device which is readable by the second processor. The second computer readable memory device includes a series of computer executable steps configured to cause the processor to: receive a transmission, the transmission including instructions to modify at least one modifiable subscribed service operating on the subordinate mobile device, the instructions originating from the senior mobile device associated with the mobile device plan, the subordinate mobile device subordinate to the senior mobile device; authenticate the received transmission; parse the authenticated received transmission; identify instructions from the parsed received transmission, the identified instructions associated with at least one modifiable subscribed service operating on the subordinate mobile device; and modify the at least one modifiable subscribed service based on the identified instructions.

### BRIEF DESCRIPTION OF THE DRAWINGS

FIG. 1 is a functional block diagram generally illustrating an embodiment of a communication system in which implementations of the invention are particularly applicable.

FIG. 2 is a functional block diagram generally illustrating an application execution environment in which implementations of the invention are particularly applicable.

FIG. 3 is a functional block diagram generally illustrating another application execution environment in which implementations of the invention are particularly applicable.

FIG. 4 is a functional block diagram generally illustrating a mobile device in which implementations of the invention are particularly applicable.

FIG. 5 is an operational flow diagram generally illustrating a process for generating instructions at a senior mobile device to control subscribed services operating on subordinate mobile device.

FIG. 6 is an operational flow diagram generally illustrating a process for receiving instructions from as senior mobile device to modify a subscribed service operating on a subordinate mobile device.

### DETAILED DESCRIPTION

What follows is a detailed description of various techniques and mechanisms for controlling services utilized by a mobile device within a wireless communications system. Very generally stated, the present invention is directed to providing one of the mobile devices within a group of mobile devices with the capabilities to enable or disable specific services available to or on the other mobile devices within the group.

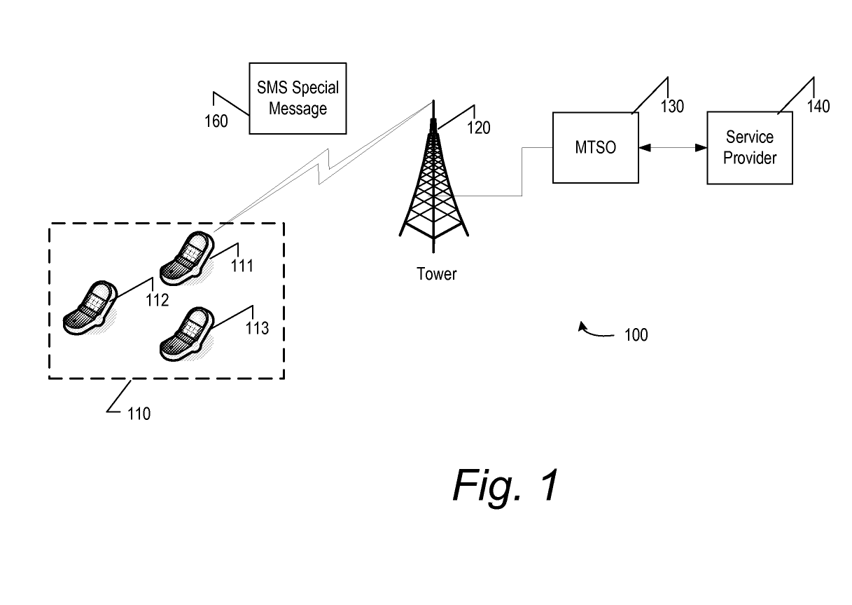

FIG. 1 is a functional block diagram generally illustrating a communication system 100 in which implementations of the invention are particularly applicable. Communication system 100 is a cellular communication network for transmitting and receiving voice and/or data communication to and from mobile devices. Communication system 100, as shown, includes hardware, such as a tower 120, and software to facilitate communication between mobile devices or between a mobile device and telecommunications equipment on another communication system, such as the Public Switched Telephone Network (PSTN).

A Mobile Telephone Switching Office (MTSO) 130 is in communication with the tower 120, and controls the general operation of the communication system 100. A service provider 140 is in communication with MTSO 130. Service provider 140 is an entity that provides telecommunications services and includes infrastructure (e.g., hardware and software) to provide subscriber services, such as voice communications, wireless internet access, wireless email access, wireless text messaging, and the like to mobile devices within communication system 100.

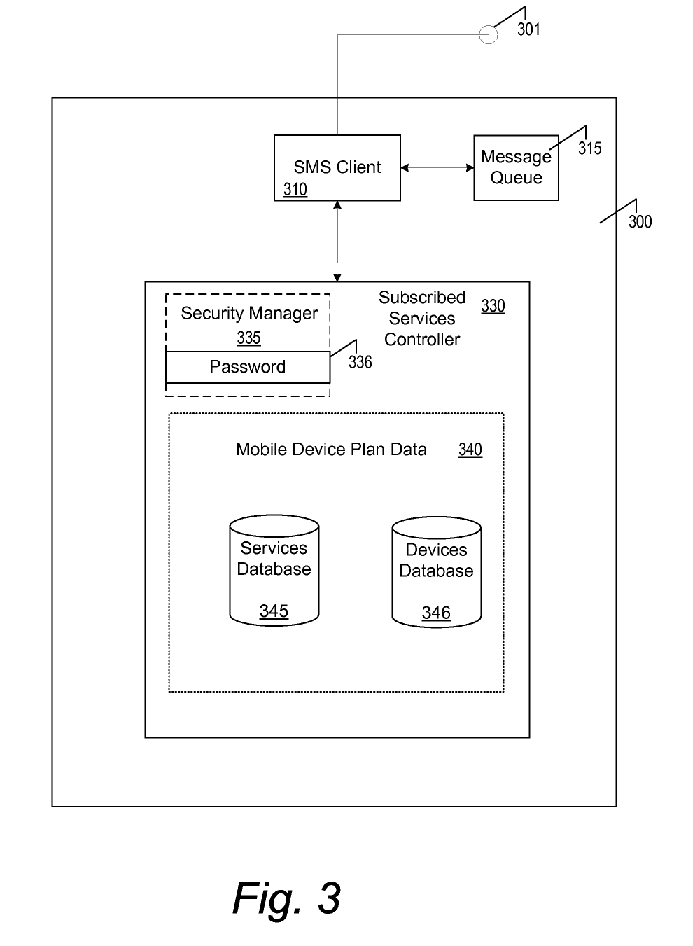

Communication system 100 further includes mobile devices 111-113 that are grouped into a common mobile device plan 110. Mobile devices 111-113 are two-way telecommunications devices, such as cellular telephones, cellular-equipped vehicles, cellular-equipped PDA devices, and the like, that are compatible with communication system 100. The mobile devices 111-113 may also be configured to receive and transmit SMS messages. In addition, each mobile device 111-113 may include other functions and/or applications, such as games, instant messaging applications, and the like. One particular embodiment of mobile devices is illustrated in further detail in FIG. 3 and described below.

Mobile device plan 110 is an administrative association of specific mobile devices as defined by service provider 140 based on a contractual relationship with the owner or operator of mobile devices 111-113. Mobile device plan 110 provides specific benefits to mobile devices registered and associated with the plan, such as sharing of available air-time (e.g., minutes), reduced air-time charges for communications between mobile devices associated within the same plan, reduced charges for exceeding the air-time usage limits defined within the plan, as well as additional services, for example caller identification, call forwarding, wireless internet access, wireless email, video telephony, other wireless entertainment (e.g., games), and the like. In one example, when mobile devices are purchased, they are provisioned based on the data within the individual device's number assignment module (NAM) and the services contracted for by the owner/operator of the mobile devices. The NAM includes the mobile identification number (MIN) of the mobile device (e.g., the wireless phone number), the system ID (SID) that identifies the cell phone system the mobile device is associated with, activation codes for activation of subscribed services available on the mobile device, and an electronic serial number (ESN) unique to the phone. The provisioning process allows the service provider to associate the mobile devices within a plan as well as implement the subscribed features.

In accordance with this embodiment, one mobile device within mobile device plan 110 is designated as a “senior” mobile device, such as senior mobile device 111. Designating one mobile device as the senior mobile device empowers it to control certain functionality or services available to the other mobile devices in the mobile device plan 110. For instance, the senior mobile device 111 can activate or deactivate certain features, applications, or other functionality of other mobile devices in the mobile device plan 110. In one implementation, the senior mobile device 111 includes the functionality to produce a special SMS message 160 with instructions that govern certain of the functionality of the other mobile devices within mobile device plan 110.

In general operation, senior mobile device 111 generates a special SMS message 160 that includes instructions governing the activation or deactivation of features available to another mobile device in the mobile device plan 110. The senior mobile device 111 transmits the special SMS message 160 to the affected other mobile device in the mobile device plan 110, such as mobile device 113, via tower 120 and MTSO 130. When mobile device 113 receives SMS special message 160, the instructions are executed and services/features operating on mobile device 113 are enabled or disabled accordingly. Such an implementation may be useful to control certain local features or applications executing on the affected mobile device 113, such as an instant messaging application, the display of video content, or the like.

In another example, senior mobile device 111 communicates with the service provider 140, such as via tower 120 and MTSO 130. Senior mobile device 111 communicates instructions relating to mobile device 113 to service provider 140 indicating which services operating on mobile device 113 are to be enabled or disabled. In this example, service provider 140 may generate and send special SMS message 160 to mobile device 113. When mobile device 113 receives SMS special message 160, the instructions are executed and services operating on mobile device 113 are enabled or disabled accordingly. Alternatively, the service provider 140 may simply alter or modify its internal databases and service offerings available to the affected mobile device 113 without resort to transmitting a message to the affected mobile device 113. Such an alternative may be useful to control certain more general features available to the mobile devices, such as data network access, long distance calling, or the like.

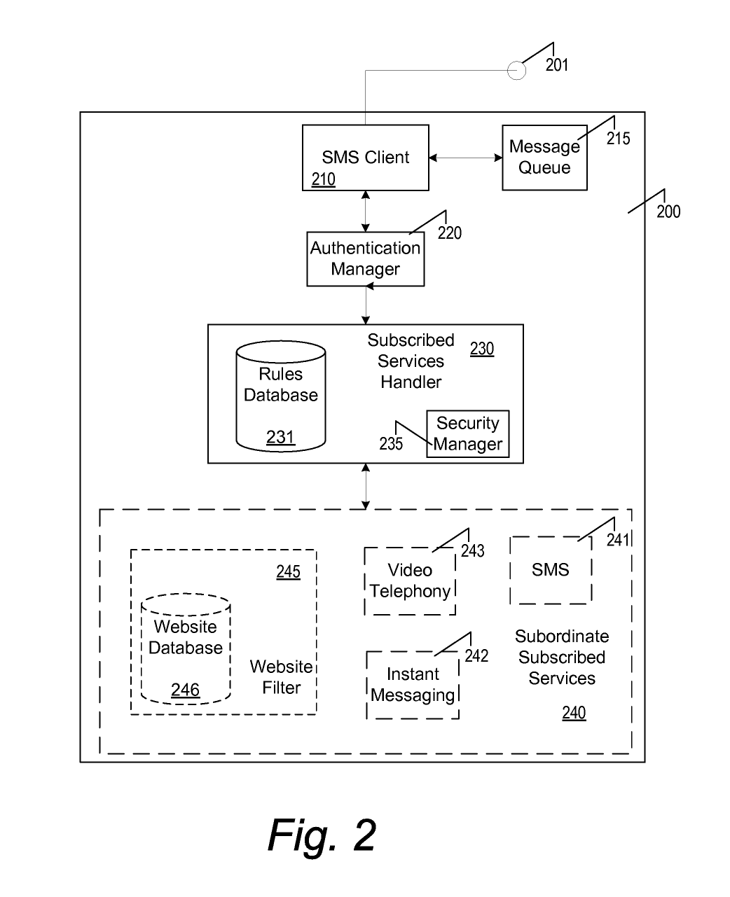

FIG. 2 is a functional block diagram generally illustrating an application execution environment 200 that may reside on a subordinate mobile device in a mobile device plan. Application execution environment 200 may be a system for executing software on a mobile device, or the like. In this embodiment, application execution environment 200 includes components to control the operation of functions and/or features within a mobile device that operates within a communication system (not shown), based on the reception of instructions from a senior mobile device.

An SMS client 210 provides general control functions for transmitting and receiving messages over a messaging transport, such as the SMS messaging protocol in common use today. The SMS client 210 may transmit and receive the messages to and from a communications component 201, and store any received messages in a message queue 215 for processing.

SMS client 210 determines a message type for each received message based on information contained within the message, such as particular headers or the like. For example, headers in a received message may indicate that the message contains instructions regarding subscribed services operating within application execution environment 200. In one embodiment, a message containing instructions regarding subscribed services originates from a senior mobile device within a mobile device plan to which the mobile device that application execution environment 200 is associated is also a member. SMS client 210 also composes messages for transmission over the messaging transport.

Authentication manager 220 provides authentication functionality for received SMS messages that include instructions for modifying subscribed services operating within application execution environment 200. Authentication manager 220 determines whether a received SMS message originated from a senior mobile device within the mobile device plan.

Subordinate subscribed services 240 include specific applications and/or services that, when enabled, implement certain features and/or functionality. Examples of subscribed services include SMS message service 241, instant messaging service 242, video telephony service 243, and web filter service 245. SMS message service 241 provides electronic messaging capability, such as text messaging and email messaging capabilities. Instant messaging 242 and video telephony 243 provide instant messaging capabilities and the capability to receive video streams, respectively. Similarly, website filter 245 provides the capability to filter and deny access to specific website location on the internet based on a “no go” listing of websites stored at website database 246. In one embodiment, the “no go” listing of websites is a service provider provided list. In another embodiment, the “no go” listing of websites is a plan owner provided list. In yet another embodiment, the “no go” listing of websites is a combination of a service provider provided list and plan owner provided list. Many other subscribed services are also possible, such as adding new subscribed services (e.g., installing new applications, games, and the like), to add other mobile devices as subordinate to the subordinate device, and the like.

Subscribed services handler 230 is an engine for evaluating received authenticated messages and, when appropriate, modifying the status of one or more subscribed services 240. Broadcast message handler 210 is in communication with SMS client 210 via authentication manager 220 as well as subordinate subscribed services 250.

In one embodiment, subscribed services handler 230 is notified by the SMS client 210 when SMS messages including instructions regarding subscribed services are received. In this embodiment, subscribed services handler 230 may apply rules stored in a rules database 231 to the instructions to determine an appropriate operation based on the instructions. In one example, the instructions and rules indicate a change in the execution state of one of the subscribed services 240. For instance, if the instructions indicate that instant messaging should be disabled on the host mobile device, the security manager 235 disables the instant messaging service 242. In another example, based on the received instructions, security manager 235 enables the website filter 245 function thereby allowing a web browser to operate in a filtered mode, based on the “no go” listing within website database 246.

FIG. 3 is a functional block diagram generally illustrating another application execution environment 300 that may reside on a senior mobile device in a mobile device plan. Application execution environment 300 may be a system for executing software on a mobile device, or the like. In this embodiment, application execution environment 300 includes components to generate instructions to control the operation of subscribed services within another mobile device, that operates within a communication system (not shown), based on a user's instructions.

An SMS client 310 provides general control functions for transmitting and receiving messages over a messaging transport, such as the SMS messaging protocol in common use today. The SMS client 310 may transmit and receive the messages to and from a communications component 301, and store any messages ready for transmission in a message queue 315.

SMS client 310 also composes messages for transmission over the messaging transport. In this embodiment, the application execution environment 300 is resident on the senior device within an associated mobile device plan. Accordingly, the SMS client 310 is configured to create a special SMS message including instructions for controlling the subscribed services on a subordinate mobile device in the mobile device plan.

Subscribed services controller 330 is a services client that includes the capability to control specific subscribed services operating on other mobile devices within the mobile device plan associated with the mobile device that application execution environment 300 is operating within. Examples of subscribed services include SMS message service, instant messaging service, video telephony service, web filtering service, and the like.

Subscribed services controller 330 includes data (mobile device plan data 340) that describes the mobile devices associated with the mobile device plan, the subscribed services associated with each device within the mobile device plan, and perhaps the person associated with each mobile device. Mobile device plan data 340 may include a devices database 346 that identifies each mobile device in the mobile device plan, and a services database 345 that identifies each available and controllable subscribed service.

Additionally, subscribed services controller 330 receives user instructions regarding subscribed services for the mobile devices within the mobile device plan, and generates instructions for the subordinate devices with the mobile device plan based on the received user instructions. More specifically, through user interaction, the subscribed services controller 330 is operative to receive user instructions to alter available subscribed services at a subordinate mobile device. Based on those user instructions, the subscribed services controller 330 creates a message, such as an SMS message, to issue to that subordinate mobile device. The message includes code and/or instructions operative to give effect to the user instructions and either enable or disable the affected subscribed services on the subordinate mobile device. That message may then be transmitted, either directly to the subordinate mobile device using the SMS client 310, or perhaps to the service provider to indirectly control the subscribed services.

Subscribed services controller 330 may optionally include a security manager 335 to verify that the user providing the instructions is authorized to do so. For instance, the security manager 335 may compare a password provided by the user to a stored password 336.

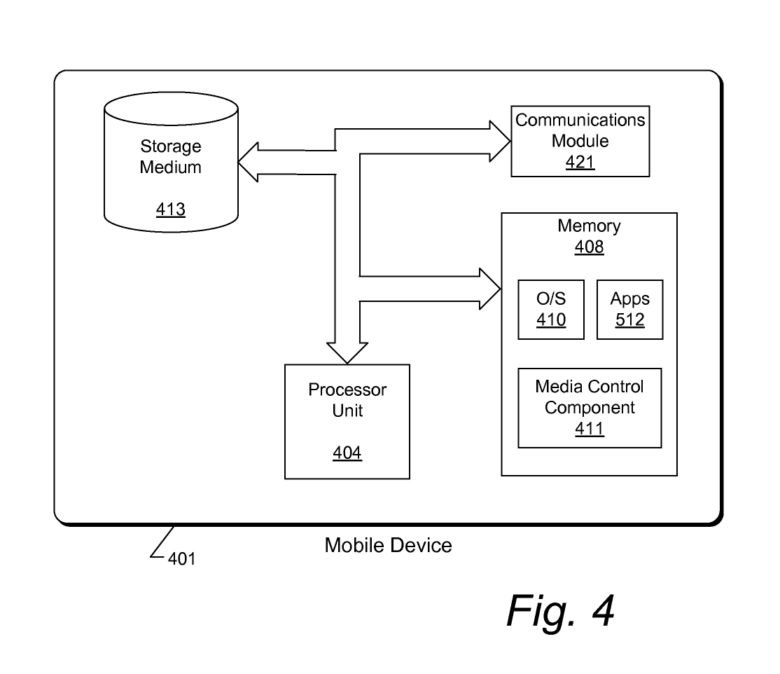

FIG. 4 is a functional block diagram generally illustrating a sample mobile device 401 in which implementations of the invention are particularly applicable. The mobile device 401 may be any handheld computing device, such as a cellular telephone, a personal digital assistant, a portable music player, a global positioning satellite (GPS) device, or the like. Although described here in the context of a handheld computing device, it should be appreciated that implementations of the invention could have equal applicability in other areas.

In this example, mobile device 401 includes a processor unit 404, a memory 408, and a storage medium 413. The processor unit 404 advantageously includes a microprocessor or a special-purpose processor such as a digital signal processor (DSP), but may in the alternative be any conventional form of processor, controller, microcontroller, or state machine. Mobile device 401 may also include additional components not relevant to the present discussion.

The processor unit 404 is coupled to the memory 408, which is advantageously implemented as RAM memory holding software instructions that are executed by the processor unit 404. In this embodiment, the software instructions stored in the memory 408 include one or more applications 412, a media control component 411, and an operating system 410. The memory 408 may be on-board RAM, or the processor unit 404 and the memory 408 could collectively reside in an Application Specific Integrated Circuit (ASIC). In an alternate embodiment, the memory 408 may be composed of firmware or flash memory, such as a SmartMedia card.

The processor unit 404 is also coupled to the storage medium 413, which may be implemented as any nonvolatile memory, such as ROM memory, flash memory, or a magnetic disk drive, just to name a few. The storage medium 413 may also be implemented as any combination of those or other technologies, such as a magnetic disk drive with cache (RAM) memory, or the like. In this particular embodiment, the storage medium 413 is used to store data during periods when the mobile device 401 may be powered off or without power.

The mobile device 401 also includes a communications module 421 that enables bidirectional communication between the mobile device 401 and one or more other computing devices. The communications module 421 may include components to enable RF or other wireless communications, such as a cellular telephone network, Bluetooth connection, wireless local or wide area network, or perhaps a Global Positioning Satellite receiver. Alternatively, the communications module 421 may include components to enable land line or hard wired network communications, such as an Ethernet connection, universal serial bus connection, IEEE 1394 (Firewire) connection, or the like. These are intended as non-exhaustive lists and many other alternatives are possible.

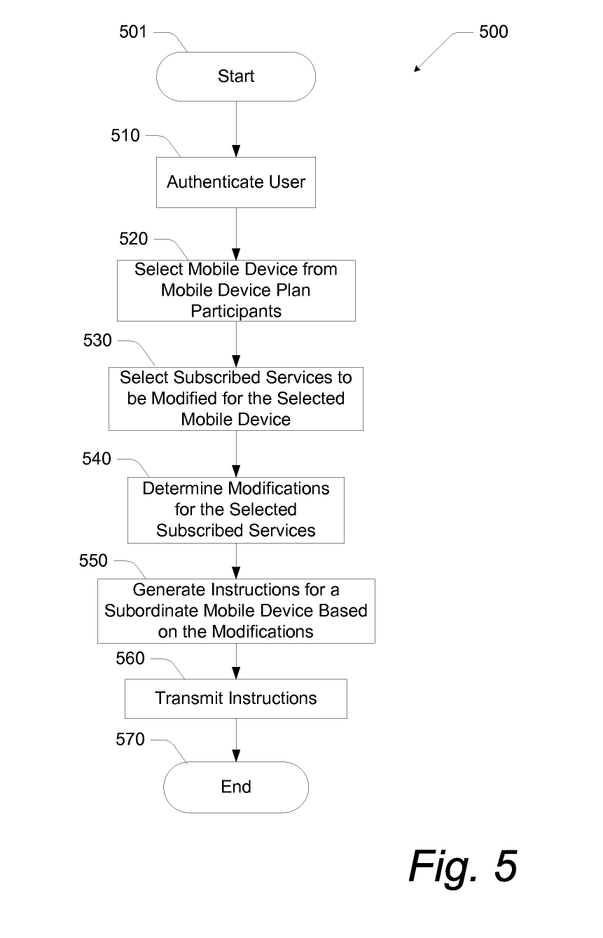

FIG. 5 is an operational flow diagram generally illustrating a method 500 for generating instructions at a senior mobile device to control subscribed services operating on subordinate mobile device that is associated with the senior mobile device via a mobile device plan. In one embodiment, method 500 is implemented with components, data, and/or the exemplary operating environments of FIGS. 1-5. Although the method 500 illustrated in FIG. 5 may be described with reference to components shown in FIGS. 1-5, it should be understood that this is merely for convenience and alternative components can be employed to implement the method 500.

Preferably, one or more steps of method 500 are embodied in a computer readable medium containing computer readable code such that a series of steps are implemented when the computer readable code is executed on a computing device. In some implementations, certain steps of method 500 are combined, performed simultaneously or in a different order, or perhaps omitted, without deviating from the objective of method 500.

Method 500 begins at step 501. At step 510, a user of the senior mobile device is authenticated. The user is authenticated to ensure that modifications made to the subordinate mobile devices are desired by the owner of the mobile device plan. In an example and referring to FIG. 3 above, a security manager 335 verifies that the user providing the instructions is authorized to do so by comparing a user provided password to a stored password 336.

At step 520, a target subordinate device is selected from the available subordinate mobile devices within the mobile device plan. In one embodiment, the subordinate mobile devices are identified by the user associated with the subordinate mobile device. In an example and referring to FIG. 3 above, mobile device plan 340 generates a list of subordinate mobile devices by retrieving mobile device identifiers from device database 346. In this example, the user is presented with a list of the available subordinate devices from which to choose one. In another embodiment, a listing of subscribed services available within the plan is provided and subordinate mobile devices within the plan are identified when a particular subscribed service is chosen. In this example, when the user identifies a subscribed service to modify, the user is presented with a list of subordinate mobile devices that have that subscribed service available. The user then identifies the subordinate mobile device.

At step 530, a target subscribed service is selected from the available services associated with the target subordinate device. In one embodiment, a list of subscribed services associated with the target mobile device is presented to the user and the user selects the subscribed service to be modified. In an example and referring to FIG. 3 above, once the target device is determined, subscribed services controller 330 generates a list of subscribed services from services database 345 that are associated with the selected device.

At step 540, modifications to the target subscribed service are determined. In one embodiment, it is determine whether the target subscribed service is to be enabled or disabled. In another embodiment, it is determined whether modifications are to be made to portion of the subscribed service, such as modifications to the “no go” website listing associated with a website filter subscribed service.

At step 550, instructions are generated for the subordinate mobile device based on the modifications to be made to the target subscribed service operating on the subordinate mobile device. In an example and referring to FIG. 3 above, subscribed services controller 330 generates instructions for the subordinate device based on the modifications to be made to the target subscribed service operating on the subordinate mobile device.

At step 560, the generated instructions for the subordinate mobile device are formatted for transmission and transmitted. In an example and referring to FIG. 3 above, the generated instructions for the subordinate mobile device are formatted for transmission and the formatted instructions are passed to SMS client 310 for transmitting to the subordinate mobile device via communications component 301, such as described in FIG. 1 above.

At step 570, method 500 ends.

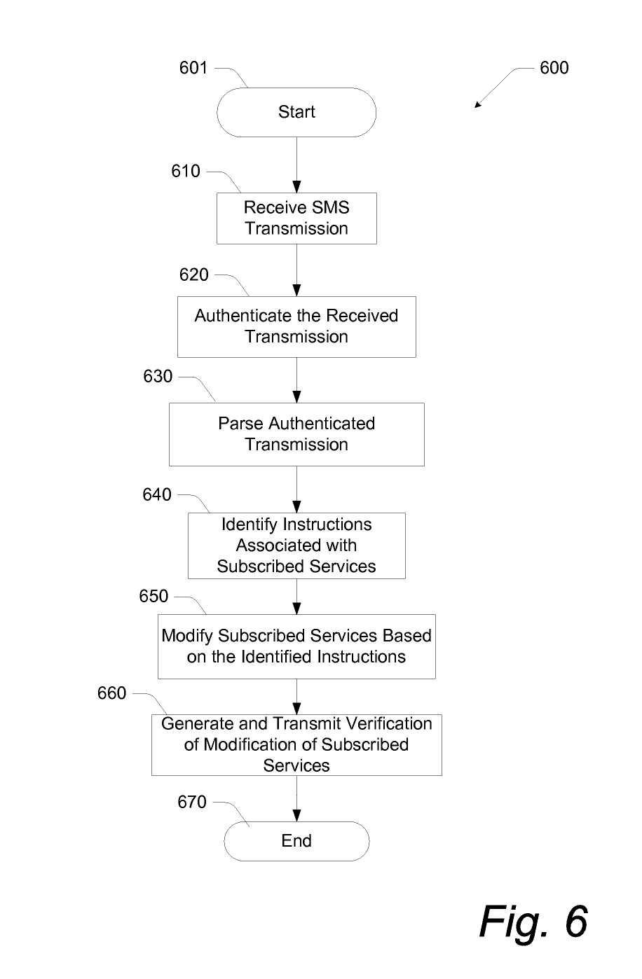

FIG. 6 is an operational flow diagram generally illustrating a method 600 for receiving instructions from as senior mobile device to modify a subscribed service operating on a subordinate mobile device that is associated with the senior mobile device via a mobile device plan. In one embodiment, method 600 is implemented with components, data, and/or the exemplary operating environments of FIGS. 1-4. Although the method 600 illustrated in FIG. 6 may be described with reference to components shown in FIGS. 1-4, it should be understood that this is merely for convenience and alternative components can be employed to implement the method 600.

Preferably, one or more steps of method 600 are embodied in a computer readable medium containing computer readable code such that a series of steps are implemented when the computer readable code is executed on a computing device. In some implementations, certain steps of method 600 are combined, performed simultaneously or in a different order, or perhaps omitted, without deviating from the objective of method 600.

Method 600 begins at step 601. At step 610, an SMS transmission is received to a subordinate mobile device. In one embodiment, when the SMS transmission is received it is passed to a message queue to await processing. In another embodiment, when the SMS transmission is received it is passed to an authentication manager for processing. In an example and referring to FIG. 2 above, an SMS transmission is received to SMS client 210 via communications component 201. In this example, the received message can be passed to message queue 215 to await processing or it can be passed to authentication manager 220 for further processing.

At step 620, the received message is authenticated. In one embodiment, the received message is authenticated using standard industry authentication methodology. The authenticated message is then passed to subscribed services handler.

At step 630, the authenticated message is then parsed for instructions. In one embodiment, the authenticated message is parsed for instructions by the subscribed services handler. In an example and referring to FIG. 2 above, the authenticated message is parsed for instructions by subscribed services handler 230.

At step 640, instructions associated with subscribed services are identified. In one embodiment, instructions associated with subscribed services operating within the subordinate subscribed services are identified. In an example and referring to FIG. 2 above, instructions associated with subscribed services operating within subordinate subscribed services 240 are identified.

At step 650, subscribed services are modified based on the identified instructions. In one embodiment, subscribed services are modified based on rules associated with the subscribed services handler and the identified instructions. In an example and referring to FIG. 2 above, subscribed services are modified based on rules retrieved from rules database 231 and associated with subscribed services handler 230 and the identified instructions. In one embodiment, the modifications enable or disable subscribed services, such as SMS message service, instant messaging service, video telephony service, web filter service, and the like. In another embodiment, the modifications modify the operation of the subscribed services, such as modifying a “no go” listing of websites stored at website database 246 that are associated with web filter service 245.

At step 660, a verification of modification of subscribed services is generated and transmitted to the senior mobile device within the mobile device plan. In one embodiment, the subscribed services handler generates the verification of modification of subscribed services and the SMS client transmits the verification of modification of subscribed services. In an example and referring to FIG. 2 above, subscribed services handler 230 generates the verification of modification of subscribed services and SMS client 210 transmits the verification of modification of subscribed services, such as described in FIG. 1 above.

At step 670, method 600 ends.

While the present invention has been described with reference to particular embodiments and implementations, it should be understood that these are illustrative only, and that the scope of the invention is not limited to these embodiments. Many variations, modifications, additions and improvements to the embodiments described above are possible. It is contemplated that these variations, modifications, additions and improvements fall within the scope of the invention as detailed within the following claims.

We claim:

1. A method for utilizing a mobile device to modify subscribed services on a subordinate mobile device within a communications system, comprising:
authenticating a user of a senior mobile device that is a member of a mobile device plan, the authentication being based on input data, the mobile device plan including at least the senior mobile device and one or more other mobile devices;
determining a subordinate mobile device from the mobile device plan members based on the input data, the subordinate mobile device having modifiable subscribed services;
determining at least one modifiable subscribed service on the determined subordinate mobile device to be modified based on the input data;
determining a modification to be applied to the at least one modifiable subscribed service based on the input data;
generating instructions for the determined subordinate mobile device based on the determined modifications to the at least one modifiable subscribed service associated with the determined subordinate mobile device; and
sending the generated instructions to the subordinate mobile device.

2. The method recited in claim 1, wherein sending the generated instructions to the subordinate mobile device comprises:
generating a short message service message including the generated instruction for the determined subordinate mobile device; and
transmitting the generated short message service message to the determined subordinate mobile device over the communications system.

3. The method recited in claim 1, wherein sending the generated instructions to the subordinate mobile device comprises communicating the generated instructions for the determined subordinate mobile device to a service provider, wherein the service provider generates a short message service message including the generated instruction for the determined subordinate mobile device, and wherein the service provider transmits the generated short message service message to the determined subordinate mobile device over the communications system.

4. The method recited in claim 3, wherein the senior mobile device communicates with the service provider using wireless internet protocol.

5. The method recited in claim 1, wherein the modification to be applied to the at least one modifiable subscribed service is selected from the list consisting of: enabling the subscribed service, disabling the subscribed service, or modifying a portion of the subscribed service.

6. The method recited in claim 1, wherein the at least one modifiable subscribed service is selected from the list consisting of: video telephony, instant messaging, short message system service, or website filtering.

7. A method for modifying subscribed services on a subordinate mobile device operating within a communication system, comprising:
receiving a transmission to a subordinate mobile device associated with a mobile device plan operating within a communications system, the transmission including instructions to modify at least one modifiable subscribed service operating on the subordinate mobile device, the instructions originating from a senior mobile device associated with the mobile device plan, the subordinate mobile device subordinate to the senior mobile device;
authenticating the received transmission;
parsing the authenticated received transmission;
identifying instructions from the parsed received transmission, the identified instructions associated with at least one modifiable subscribed service operating on the subordinate mobile device; and
modifying the at least one modifiable subscribed service based on the identified instructions.

8. The method recited in claim 7, further comprising:
generating a verification of modification of subscribed services; and
transmitting the generated verification.

9. The method recited in claim 7, wherein the received transmission is a short message system message generated by the senior mobile device.

10. The method recited in claim 7, wherein the received transmission is a short message system message generated by a service provider based on instructions received at the service provider from the senior mobile device.

11. The method recited in claim 7, wherein the modification to be applied to the at least one modifiable subscribed service is selected from the list consisting of: enabling the subscribed service, disabling the subscribed service, or modifying a portion of the subscribed service.

12. The method recited in claim 7, wherein the at least one modifiable subscribed service is selected from the list consisting of: video telephony, instant messaging, short message system service, or website filtering.

13. A system for providing a senior mobile device of a mobile device plan with remote control of subscribed services operating on a subordinate mobile device, the system comprising:
a cellular communication system infrastructure;
a senior mobile device comprising:
a first communication bus;
at least a first communication port;
a first user interface;
at least a first processor;
at least a first memory storage device in communication with the processor; and
a first computer readable memory device which is readable by the first processor, the first computer readable memory device including a series of computer executable steps configured to cause the first processor to:
determine a subordinate mobile device from members of a mobile device plan, based on input data, the subordinate mobile device having modifiable subscribed services;
determine at least one modifiable subscribed service, operating on the determined subordinate mobile device, to be modified based on the input data;
determine a modification to be applied to the at least one modifiable subscribed service based on the input data;
generate instructions for the determined subordinate mobile device based on the determined modifications to the at least one modifiable subscribed service associated with the determined subordinate mobile device; and
send the generated instructions to the subordinate mobile device; and
a subordinate mobile device associated with the mobile device plan and in communication with the senior mobile device, the subordinate mobile device comprising:
a second communication bus;
at least a second communication port;
a second user interface;
at least a second processor;
at least a second memory storage device in communication with the processor; and
at least a second computer readable memory device which is readable by the second processor, the second computer readable memory device including a series of computer executable steps configured to cause the processor to:
receive a transmission, the transmission including instructions to modify at least one modifiable subscribed service operating on the subordinate mobile device, the instructions originating from the senior mobile device associated with the mobile device plan, the subordinate mobile device subordinate to the senior mobile device;
authenticate the received transmission;
parse the authenticated received transmission;
identify instructions from the parsed received transmission, the identified instructions associated with at least one modifiable subscribed service operating on the subordinate mobile device; and
modify the at least one modifiable subscribed service based on the identified instructions.

14. The system of claim 13, wherein the computer executable steps configured to cause the processor to send the generated instructions to the subordinate mobile device comprises computer executable steps configured to cause the processor to:
generate a short message service message including the generated instruction for the determined subordinate mobile device; and
transmit the generated short message service message to the determined subordinate mobile device over the cellular communication system infrastructure.

15. The system of claim 14, wherein the transmission received by the subordinate mobile device is a short message system message generated by the senior mobile device.

16. The system of claim 13, wherein the computer executable steps configured to cause the processor to send the generated instructions to the subordinate mobile device comprises computer executable steps configured to cause the processor to communicate the generated instructions for the determined subordinate mobile device to a service provider, wherein the service provider generates a short message service message including the generated instruction for the determined subordinate mobile device, and wherein the service provider transmits the generated short message service message to the determined subordinate mobile device over the communications system.

17. The system of claim 16, wherein the transmission received by the subordinate mobile device is a short message system message generated by the service provider based on instructions received at the service provider from the senior mobile device.

18. The system of claim 13, wherein the senior mobile device communicates with the service provider using wireless internet protocol.

19. The system of claim 13, wherein the modification to be applied to the at least one modifiable subscribed service is selected from the list consisting of: enabling the subscribed service, disabling the subscribed service, or modifying a portion of the subscribed service.

20. The system of claim 13, wherein the at least one modifiable subscribed service is selected from the list consisting of: video telephony, instant messaging, short message system service, or website filtering.

21. The system of claim 13, wherein the second computer readable memory device additionally including a series of computer executable steps configured to cause the processor to:
generate a verification of modification of subscribed services; and
transmit the generated verification.

22. A computer readable medium storing a computer program to utilize a mobile device to modify subscribed services on a subordinate mobile device within a communications system, comprising:
computer readable code to authenticate a user of a senior mobile device that is a member of a mobile device plan, the authentication based on input data, the mobile device plan including at least the senior mobile device and one or more subordinate mobile devices that are subordinate to the senior mobile device;
computer readable code to determine a subordinate mobile device, from the mobile device plan members, based on the input data, the subordinate mobile device having modifiable subscribed services;
computer readable code to determine at least one modifiable subscribed service, operating on the determined subordinate mobile device, to be modified based on the input data;
computer readable code to determine a modification to be applied to the at least one modifiable subscribed service based on the input data;
computer readable code to generate instructions for the determined subordinate mobile device based on the determined modifications to the at least one modifiable subscribed service associated with the determined subordinate mobile device; and
computer readable code to send the generated instructions to the subordinate mobile device.

23. The computer readable medium of claim 22, wherein computer readable code to send the generated instructions to the subordinate mobile device, comprises:
computer readable code to generate a short message service message including the generated instruction for the determined subordinate mobile device; and
computer readable code to transmit the generated short message service message to the determined subordinate mobile device over the communications system.

24. The computer readable medium of claim 22, wherein computer readable code to send the generated instructions to the subordinate mobile device comprises computer readable code to communicate the generated instructions for the determined subordinate mobile device to a service provider, wherein the service provider generates a short message service message including the generated instruction for the determined subordinate mobile device, and wherein the service provider transmits the generated short message service message to the determined subordinate mobile device over the communications system.

25. The computer readable medium of claim 24, wherein the senior mobile device communicates with the service provider using wireless internet protocol.

26. The computer readable medium of claim 22, wherein the modification to be applied to the at least one modifiable subscribed service is selected from the list consisting of: enabling the subscribed service, disabling the subscribed service, or modifying a portion of the subscribed service.

27. The computer readable medium of claim 22, wherein the at least one modifiable subscribed service is selected from the list comprised of: video telephony, instant messaging, short message system service, or website filtering.

28. A computer readable medium storing a computer program to modify subscribed services on a subordinate mobile device operating within a communication system, comprising:
computer readable code to receive a transmission to a subordinate mobile device associated with a mobile device plan operating within a communications system, the transmission including instructions to modify at least one modifiable subscribed service operating on the subordinate mobile device, the instructions originating from a senior mobile device associated with the mobile device plan, the subordinate mobile device subordinate to the senior mobile device;
computer readable code to authenticating the received transmission;
computer readable code to parsing the authenticated received transmission;
computer readable code to identify instructions from the parsed received transmission, the identified instructions associated with at least one modifiable subscribed service operating on the subordinate mobile device; and
computer readable code to modify the at least one modifiable subscribed service based on the identified instructions.

29. The computer readable medium of claim 28, further comprising:
computer readable code to generate a verification of modification of subscribed services; and
computer readable code to transmit the generated verification.

30. The computer readable medium of claim 28, wherein the received transmission is a short message system message generated by the senior mobile device.

31. The computer readable medium of claim 28, wherein the received transmission is a short message system message generated by a service provider based on instructions received at the service provider from the senior mobile device.

32. The computer readable medium of claim 28, wherein the modification to be applied to the at least one modifiable subscribed service is selected from the list comprised of: enabling the subscribed service, disabling the subscribed service, or modifying a portion of the subscribed service.

33. The computer readable medium of claim 28, wherein the at least one modifiable subscribed service is selected from the list comprised of: video telephony, instant messaging, short message system service, or website filtering.
